(19) United States
(12) Patent Application Publication
(10) Pub. No.: US 2024/0193510 A1
(43) Pub. Date: Jun. 13, 2024

(54) SYSTEMS AND METHODS FOR AUTOMATED PERSON DETECTION AND NOTIFICATION

(71) Applicant: Walmart Apollo, LLC, Bentonville, AR (US)

(72) Inventors: Arun Prasad NAGARATHINAM, Santa Clara, CA (US); Sahana VIJAYKUMAR, Sunnyvale, CA (US); Madhavan Kandhadai VASANTHAM, Dublin, CA (US); Shivang BHATT, Sunnyvale, CA (US)

(21) Appl. No.: 18/583,438

(22) Filed: Feb. 21, 2024

Related U.S. Application Data
(63) Continuation of application No. 16/598,709, filed on Oct. 10, 2019, now abandoned.
(60) Provisional application No. 62/788,568, filed on Jan. 4, 2019.

(51) Int. Cl. G06Q 10/0631; G06V 20/52

(52) U.S. Cl. CPC G06Q 10/06312; G06V 20/52

(57) ABSTRACT

A method and system of automated person detection and notification is disclosed. Imaging data is received from at least one imaging device configured to provide a field-of-view of a predetermined area associated with a retail location. An image recognition process is implemented and configured to identify at least one person in the image data and an alert indicating at least one person is identified within the image data is generated. The alert is provided to at least one device registered to a predetermined user.

### CROSS-REFERENCE TO RELATED APPLICATIONS

This application is a continuation of U.S. patent application Ser. No. 16/598,709, filed on Oct. 10, 2019, and entitled, “SYSTEMS AND METHODS FOR AUTOMATED PERSON DETECTION AND NOTIFICATION,” which claims the benefit under 35 U.S.C. § 119(e) to U.S. Provisional Appl. Ser. No. 62/788,568, filed on Jan. 4, 2019, and entitled “SYSTEMS AND METHODS FOR AUTOMATED PERSON DETECTION AND NOTIFICATION,” each of which is incorporated herein by reference in its respective entirety.

### TECHNICAL FIELD

This application relates generally to image recognition and, more particularly, relates to image recognition of one or more persons.

### BACKGROUND

Physical service centers, such as retail stores, service locations, etc., can include multiple departments each offering products and/or services of a specific type or category. Some departments have higher customer engagement (i.e., use/foot traffic) than other departments. For operators of retail or other stores, it is not economical to have an employee positioned at a low-traffic department or location full-time, as such employee will be underutilized.

In order to more efficiently utilize employee time and resources, a single employee can be assigned to multiple duties, including being responsible for responding to customers in one or more low-traffic areas or department. Such employees may also be assigned additional duties to perform while not helping customers in their designated areas, such as, for example, stocking, inventory, cleaning, etc. If the additionally assigned duties require the employee to be away from the assigned low-traffic areas, the employee may not be aware of a customer that has arrived to utilize the low-traffic department or service.

### SUMMARY

In various embodiments, a system including a computing device is disclosed. The computing device is configured to receive imaging data from at least one imaging device configured to provide a field-of-view of a predetermined area associated with a retail location and implement an image recognition process configured to identify at least one person in the image data. The computing device is further configured to generate an alert indicating at least one person was identified within the image data. The alert is provided to at least one device registered to a predetermined user.

In various embodiments, a non-transitory computer readable medium having instructions stored thereon is disclosed. The instructions, when executed by a processor cause a device to perform operations including receiving imaging data from at least one imaging device configured to provide a field-of-view of a predetermined area associated with a retail location and implementing an image recognition process configured to identify at least one person in the image data. An alert indicating at least one person is identified within the image data is generated and provided to at least one device registered to a predetermined user.

In various embodiments, a method is disclosed. The method includes the steps of receiving imaging data from at least one imaging device configured to provide a field-of-view of a predetermined area associated with a retail location and implementing an image recognition process configured to identify at least one person in the image data. An alert indicating at least one person is identified within the image data is generated and provided to at least one device registered to a predetermined user.

### BRIEF DESCRIPTION OF THE DRAWINGS

The features and advantages will be more fully disclosed in, or rendered obvious by the following detailed description of the preferred embodiments, which are to be considered together with the accompanying drawings wherein like numbers refer to like parts and further wherein:

FIG. 1 illustrates a block diagram of a computer system, in accordance with some embodiments.

FIG. 2 illustrates a network configured to provide automated person identification and alerting, in accordance with some embodiments.

FIG. 3 is a flowchart illustrating a method of identifying a person within a predetermined area and generating an alert, in accordance with some embodiments.

FIG. 4 is a system diagram illustrating various system elements during execution of the method of identifying and alerting illustrated in FIG. 3, in accordance with some embodiments.

### DETAILED DESCRIPTION

The ensuing description provides preferred exemplary embodiment(s) only and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes can be made in the function and arrangement of elements without departing from the spirit and scope as set forth in the appended claims.

In various embodiments, a system including a computing device is disclosed. The computing device is configured to receive imaging data from at least one imaging device configured to provide a field-of-view of a predetermined area associated with a retail location and implement an image recognition process configured to identify at least one person in the image data. The computing device is further configured to generate an alert indicating at least one person was identified within the image data. The alert is provided to at least one device registered to a predetermined user.

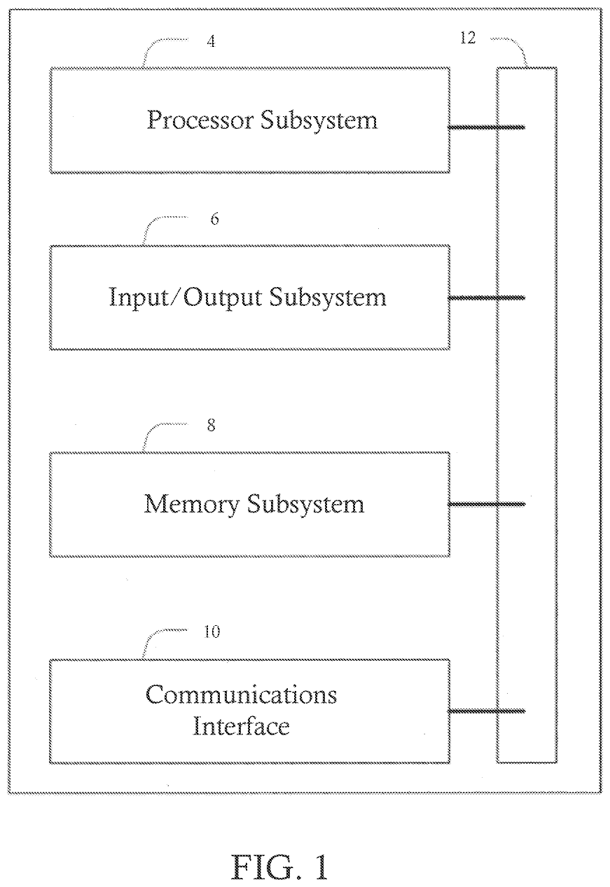

FIG. 1 illustrates a computer system configured to implement one or more processes, in accordance with some embodiments. The system 2 is a representative device and may comprise a processor subsystem 4, an input/output subsystem 6, a memory subsystem 8, a communications interface 10, and a system bus 12. In some embodiments, one or more than one of the system 2 components may be combined or omitted such as, for example, not including an input/output subsystem 6. In some embodiments, the system 2 may comprise other components not combined or comprised in those shown in FIG. 1. For example, the system 2 may also include, for example, a power subsystem. In other embodiments, the system 2 may include several instances of the components shown in FIG. 1. For example, the system 2 may include multiple memory subsystems 8. For the sake of conciseness and clarity, and not limitation, one of each of the components is shown in FIG. 1.

The processor subsystem 4 may include any processing circuitry operative to control the operations and performance of the system 2. In various aspects, the processor subsystem 4 may be implemented as a general purpose processor, a chip multiprocessor (CMP), a dedicated processor, an embedded processor, a digital signal processor (DSP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The processor subsystem 4 also may be implemented by a controller, a microcontroller, an application specific integrated circuit (ASIC), a field programmable gate array (FPGA), a programmable logic device (PLD), and so forth.

In various aspects, the processor subsystem 4 may be arranged to run an operating system (OS) and various applications. Examples of an OS comprise, for example, operating systems generally known under the trade name of Apple OS, Microsoft Windows OS, Android OS, Linux OS, and any other proprietary or open source OS. Examples of applications comprise, for example, network applications, local applications, data input/output applications, user interaction applications, etc.

In some embodiments, the system 2 may comprise a system bus 12 that couples various system components including the processing subsystem 4, the input/output subsystem 6, and the memory subsystem 8. The system bus 12 can be any of several types of bus structure(s) including a memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect Card International Association Bus (PCMCIA), Small Computers Interface (SCSI) or other proprietary bus, or any custom bus suitable for computing device applications.

In some embodiments, the input/output subsystem 6 may include any suitable mechanism or component to enable a user to provide input to system 2 and the system 2 to provide output to the user. For example, the input/output subsystem 6 may include any suitable input mechanism, including but not limited to, a button, keypad, keyboard, click wheel, touch screen, motion sensor, microphone, camera, etc.

In some embodiments, the input/output subsystem 6 may include a visual peripheral output device for providing a display visible to the user. For example, the visual peripheral output device may include a screen such as, for example, a Liquid Crystal Display (LCD) screen. As another example, the visual peripheral output device may include a movable display or projecting system for providing a display of content on a surface remote from the system 2. In some embodiments, the visual peripheral output device can include a coder/decoder, also known as Codecs, to convert digital media data into analog signals. For example, the visual peripheral output device may include video Codecs, audio Codecs, or any other suitable type of Codec.

The visual peripheral output device may include display drivers, circuitry for driving display drivers, or both. The visual peripheral output device may be operative to display content under the direction of the processor subsystem 6. For example, the visual peripheral output device may be able to play media playback information, application screens for application implemented on the system 2, information regarding ongoing communications operations, information regarding incoming communications requests, or device operation screens, to name only a few.

In some embodiments, the communications interface 10 may include any suitable hardware, software, or combination of hardware and software that is capable of coupling the system 2 to one or more networks and/or additional devices. The communications interface 10 may be arranged to operate with any suitable technique for controlling information signals using a desired set of communications protocols, services or operating procedures. The communications interface 10 may comprise the appropriate physical connectors to connect with a corresponding communications medium, whether wired or wireless.

Vehicles of communication comprise a network. In various aspects, the network may comprise local area networks (LAN) as well as wide area networks (WAN) including without limitation Internet, wired channels, wireless channels, communication devices including telephones, computers, wire, radio, optical or other electromagnetic channels, and combinations thereof, including other devices and/or components capable of/associated with communicating data. For example, the communication environments comprise in-body communications, various devices, and various modes of communications such as wireless communications, wired communications, and combinations of the same.

Wireless communication modes comprise any mode of communication between points (e.g., nodes) that utilize, at least in part, wireless technology including various protocols and combinations of protocols associated with wireless transmission, data, and devices. The points comprise, for example, wireless devices such as wireless headsets, audio and multimedia devices and equipment, such as audio players and multimedia players, telephones, including mobile telephones and cordless telephones, and computers and computer-related devices and components, such as printers, network-connected machinery, and/or any other suitable device or third-party device.

Wired communication modes comprise any mode of communication between points that utilize wired technology including various protocols and combinations of protocols associated with wired transmission, data, and devices. The points comprise, for example, devices such as audio and multimedia devices and equipment, such as audio players and multimedia players, telephones, including mobile telephones and cordless telephones, and computers and computer-related devices and components, such as printers, network-connected machinery, and/or any other suitable device or third-party device. In various implementations, the wired communication modules may communicate in accordance with a number of wired protocols. Examples of wired protocols may comprise Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, to name only a few examples.

Accordingly, in various aspects, the communications interface 10 may comprise one or more interfaces such as, for example, a wireless communications interface, a wired communications interface, a network interface, a transmit interface, a receive interface, a media interface, a system interface, a component interface, a switching interface, a chip interface, a controller, and so forth. When implemented by a wireless device or within wireless system, for example, the communications interface 10 may comprise a wireless interface comprising one or more antennas, transmitters, receivers, transceivers, amplifiers, filters, control logic, and so forth.

In various aspects, the communications interface 10 may provide data communications functionality in accordance with a number of protocols. Examples of protocols may comprise various wireless local area network (WLAN) protocols, including the Institute of Electrical and Electronics Engineers (IEEE) 802.xx series of protocols, such as IEEE 802.11a/b/g/n, IEEE 802.16, IEEE 802.20, and so forth. Other examples of wireless protocols may comprise various wireless wide area network (WWAN) protocols, such as GSM cellular radiotelephone system protocols with GPRS, CDMA cellular radiotelephone communication systems with 1xRTT, EDGE systems, EV-DO systems, EV-DV systems, HSDPA systems, and so forth. Further examples of wireless protocols may comprise wireless personal area network (PAN) protocols, such as an Infrared protocol, a protocol from the Bluetooth Special Interest Group (SIG) series of protocols (e.g., Bluetooth Specification versions 5.0, 6, 7, legacy Bluetooth protocols, etc.) as well as one or more Bluetooth Profiles, and so forth. Yet another example of wireless protocols may comprise near-field communication techniques and protocols, such as electro-magnetic induction (EMI) techniques. An example of EMI techniques may comprise passive or active radio-frequency identification (RFID) protocols and devices. Other suitable protocols may comprise Ultra Wide Band (UWB), Digital Office (DO), Digital Home, Trusted Platform Module (TPM), ZigBee, and so forth.

In some embodiments, at least one non-transitory computer-readable storage medium is provided having computer-executable instructions embodied thereon, wherein, when executed by at least one processor, the computer-executable instructions cause the at least one processor to perform embodiments of the methods described herein. This computer-readable storage medium can be embodied in memory subsystem 8.

In some embodiments, the memory subsystem 8 may comprise any machine-readable or computer-readable media capable of storing data, including both volatile/non-volatile memory and removable/non-removable memory. The memory subsystem 8 may comprise at least one non-volatile memory unit. The non-volatile memory unit is capable of storing one or more software programs. The software programs may contain, for example, applications, user data, device data, and/or configuration data, or combinations therefore, to name only a few. The software programs may contain instructions executable by the various components of the system 2.

In various aspects, the memory subsystem 8 may comprise any machine-readable or computer-readable media capable of storing data, including both volatile/non-volatile memory and removable/non-removable memory. For example, memory may comprise read-only memory (ROM), random-access memory (RAM), dynamic RAM (DRAM), Double-Data-Rate DRAM (DDR-RAM), synchronous DRAM (SDRAM), static RAM (SRAM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk memory (e.g., floppy disk, hard drive, optical disk, magnetic disk), or card (e.g., magnetic card, optical card), or any other type of media suitable for storing information.

In one embodiment, the memory subsystem 8 may contain an instruction set, in the form of a file for executing various methods, such as methods including A/B testing and cache optimization, as described herein. The instruction set may be stored in any acceptable form of machine readable instructions, including source code or various appropriate programming languages. Some examples of programming languages that may be used to store the instruction set comprise, but are not limited to: Java, C, C++, C#, Python, Objective-C, Visual Basic, or .NET programming. In some embodiments a compiler or interpreter is comprised to convert the instruction set into machine executable code for execution by the processing subsystem 4.

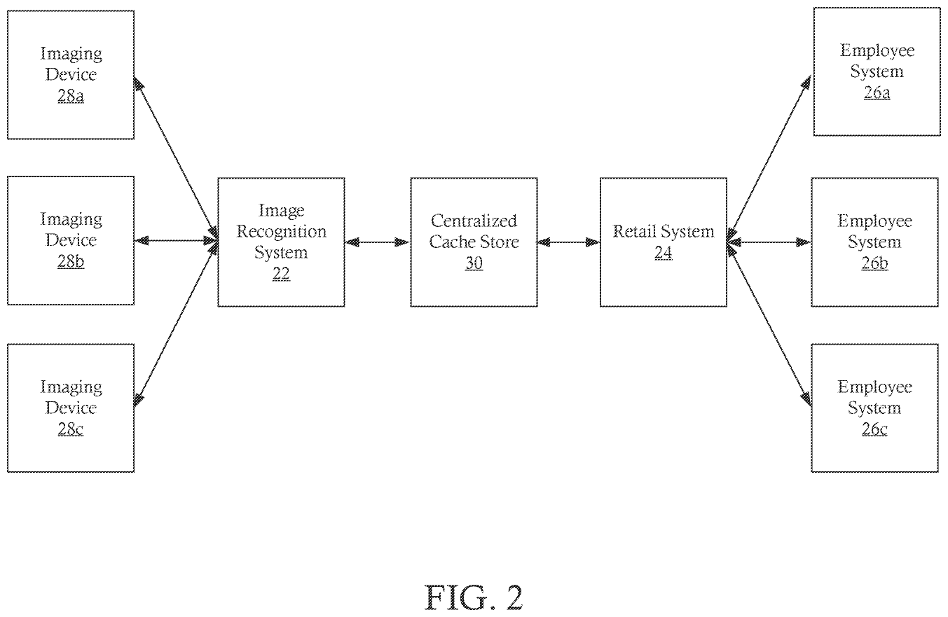

FIG. 2 illustrates a network 20 including an image recognition system 22, a retail system 24, and a plurality of employee systems (or devices) 26a-26c. Each of the systems 22-26c can include a system 2 as described above with respect to FIG. 1, and similar description is not repeated herein. Although the systems are each illustrated as independent systems, it will be appreciated that each of the systems may be combined, separated, and/or integrated into one or more additional systems. For example, in some embodiments, image recognition system 22, the retail system 24, and the employee systems 26a-26c may be implemented by a shared server or shared network system.

In some embodiments, an image recognition system 22 is configured to receive image data input (e.g., still images, dynamic images, etc.) from one or more image sources 28a-28c. The image sources 28a-28c can include any suitable image source, such as, for example, an analog camera, a digital camera having a charge-coupled device (CCD), a complementary metal-oxide semiconductor, or other digital image sensor, and/or any other suitable imaging source. The image sources 28a-28c can provide images in any suitable spectrum, such as, for example, a visible spectrum, infrared spectrum, etc. The image input may be received in real-time and/or on a predetermined delay.

In some embodiments, and as discussed in greater detail below, the image recognition system 22 is configured to implement one or more image recognition processes to identify the presence of one or more persons in the image data input. For example, in various embodiments, the image recognition system is configured to detect a person within one or more predefined boundaries within the image data (e.g., corresponding to a predetermined area within a physical space such as a retail store), movement of a person within the image data, and/or any other suitable person detection mechanism. When a person is identified, the image recognition system notifies a retail system 24. In some embodiments, the image recognition system 22 is configured to update a database or other centralized cache storage 30 each time a person is detected within the predetermined portion of the image data.

The retail system 24 is receives the notification from the image recognition system 22, for example, by polling the centralized cache store 30. After receiving a notification, the retail system 24 is configured to generate one or more alerts, as discussed in greater detail below. The one or more alerts indicate the presence of at least one person within the predetermined area and are provided to one or more employee devices 26a-26c. In some embodiments, each of the employee devices 26a-26c are registered to a specific employee and the retail system 24 identifies one or more of the registered devices 26a-26c to receive the alert. The retail system 24 can be configured to select the set of employee devices 26a-26c based on one or more factors, such as, for example, the number of people identified by the image detection system 22 within the predetermined area, the time since detection of one or more persons by the image detection system 22, the employee(s) associated with each of the employee devices 26a-26c, and/or any other suitable criteria.

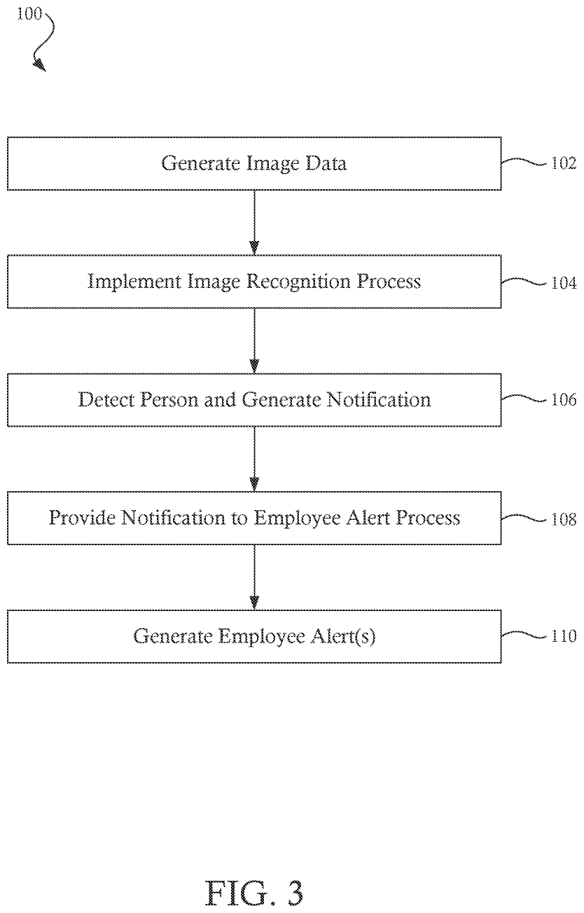

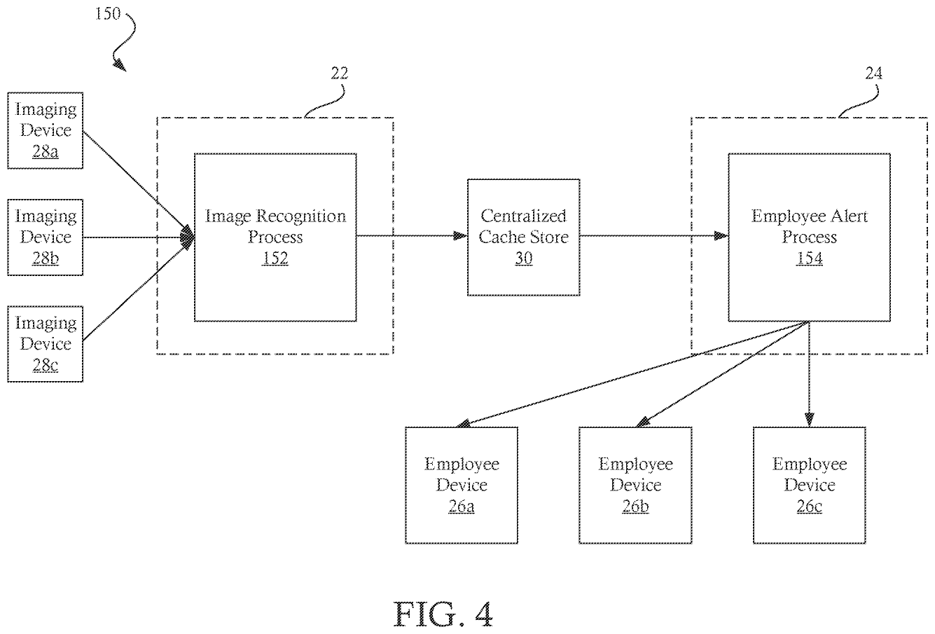

FIG. 3 is a flowchart illustrating a method 100 of identifying a person within a designated area and generating an alert, in accordance with some embodiments. FIG. 4 is a system diagram 150 illustrating various system elements during execution of the method 100 of identifying and alerting illustrated in FIG. 3, in accordance with some embodiments. At step 102, image data is generated by one or more imaging devices 28a-28c configured to monitor (e.g., generate image data of) at least a portion of a physical environment, such as a retail store, service location, etc. The image data is provided to an image recognition process 152 implemented by one or more systems, such as the image recognition system 22 discussed above with respect to FIG. 2.

At step 104, the image recognition system 22 implements an image recognition process 152 to determine if one or more persons are included in the image data (i.e., one or more persons are within a predetermined area of a physical location). The image recognition process 152 can include any suitable process configured to detect the presence of one or more people within the image data. In some embodiments, the image recognition process 152 is configured to detect persons within a predetermined portion of the image data corresponding to a predetermined area within a physical location, such as a retail or service counter. Although steps 102 and 104 are illustrated as discrete steps, it will be appreciated that the imaging devices 28a-28c can be configured to provide a continuous stream of still and/or dynamic images to the image recognition process 152. The image recognition process 152 can be configured to receive the continuous stream of image data and perform continuous image detection on the image data stream. In other embodiments, the imaging devices 28a-28c are configured to provide discrete images at predetermined intervals. The predetermined intervals may be set by the imaging devices 28a-28c, an image processing system 22, and/or a retail system 24. In still other embodiments, generation and processing of the image data can be triggered by one or more sensors coupled to the image devices 28a-28c and/or the image recognition system 22, such as, for example, a motion sensor configured to detect motion within the predetermined area.

At step 106, the image recognition process 152 detects at least one person (e.g., a first person) within the image data and/or the predetermined portion of the image data and generates a notification. In some embodiments, the notification includes an update to one or more centralized cache stores 30. For example, the image recognition process 152 can generate a cache update request including a notification that is provided to one or more cache update services configured to update the centralized cache store 30. It will be appreciated that the notification can be provided directly to the centralized cache store 30 and/or another system, such as the retail system 24. Although embodiments are discussed herein including a centralized cache store 30, it will be appreciated that the notifications generated by the image recognition process 152 can be provided directly to any suitable system, such as the retail system 24.

In some embodiments, a notification is generated for a first frame containing a person.

For example, when a person is first detected within the image data and/or the predetermined portion of the image data, the notification is generated and provided to the centralized cache store 30. In other embodiments, the image recognition process 152 is configured to wait a predetermined number of frames (corresponding to a predetermined time period) before generating a notification and/or generates a notification only when the person (e.g., first person) is detected in a predetermined number of the frames. For example, in some embodiments, the image recognition process 152 generates a notification only when a person is detected within every frame in a predetermined number of frames (e.g., is continuously within the image data or the predetermined portion of the image data). In other embodiments, only a subset of the frames within a predetermined number of frames may need to contain the person for a notification to be generated, such as a first frame and a last frame within a predetermined number of frames.

In some embodiments, the image recognition process 152 is configured to generate a count of the number of persons identified within the image data. For example, in some embodiments, the image recognition process 152 can identify two or more persons within the image data. In some embodiments, the image recognition process 152 generates a notification including a variable equal to the number of persons identified in the image data. In some embodiments, the image recognition process 152 may generate a notification only when the number of persons in the image data exceeds a predetermined threshold, such as, for example, one, two, three, etc. In other embodiments, the image recognition process 152 generates a notification for each person detected and a downstream process (such as the employee alert process 154) generates a count based on the number of notifications generated by the image recognition process 152.

In some embodiments, the image recognition process 152 is configured to track each unique person within the image data over a predetermined period. The image recognition process 152 can be configured to implement one or more suitable tracking techniques to identify and track each person within the image data, such as motion tracking, target tracking, target tagging, etc. In some embodiments, the image recognition process 152 tracks each person to prevent double-counting of a person as multiple persons within a set of frames and/or over a predetermined time period.

For example, a first person is detected in a frame f₀ of the image data, corresponding to a time t₀ (e.g., the first person is within a predetermined area of a physical location). In a second frame f₁ received at time t₁, the first person is not detected (e.g., the first person has left the predetermined area within the physical location). In a third frame, f₂ received at time t₂, the first person is again detected within the image data (e.g., has returned to the predetermined area within the physical location). If frame f₂ is within a predetermined number of frames of frame f₀ and/or the time between t₂ and t₀ is less than a predetermined threshold, the image recognition process 152 does not register the first person as a newly detected person. However, if frame f₂ is not within a predetermined number of frames of f₀ and/or the time between t₂ and t₀ is greater than the predetermined threshold, the image recognition process 152 registers the first person as a new person in the image data (and potentially generates a notification based on a new detection). Although specific embodiments are discussed herein, it will be appreciated that additional or alternative methods for preventing double-counting of unique persons can be implemented by the image recognition process 152.

At step 108, the notification from the image recognition process 152 is provided to an employee alert process 154. In some embodiments, the image recognition process 152 can provide the notification as an update to a cache storage, such as a centralized cache store 30, when one or more persons are detected within the image data. The employee alert process 154 can be configured to poll the cache store 30 to retrieve updated entries, such as the updated notification regarding the one or more persons in the image data. When a new notification is published to the cache store 30, the employee alert process 154 retrieves and processes the notification. In other embodiments, the employee alert process 154 is configured to receive a notification directly from the image recognition process 152. The employee alert process 154 may be implemented by any suitable system, such as, for example, the retail system 24 described above with reference to FIG. 2.

At step 110, at least one employee alert is generated and provided to at least one employee device 26a-26c. The employee alert may be generated according to one or more rules implemented by the employee alert process 154. For example, in some embodiments, the employee alert process 154 is configured to generate an employee alert each time a person is detected within the predetermined area of the store. In other embodiments, the employee alert process 154 is configured to delay generation of an employee alert. For example, the employee alert process 154 may be configured to generate an employee alert after a predetermined number of persons are detected within the predetermined area, after one or more persons are present in the predetermined area for a predetermined time period, etc.

In some embodiments, the generated employee alert is provided to a subset of the employee devices 26a-26c. For example, in some embodiments, each employee in a retail location has at least one employee device 26a-26c registered with the employee alert process 154. The employee devices 26a-26c can include personal devices or contact (e.g., personal cell phone, personal computer with e-mail, instant messaging, etc.) and/or devices issued by an employer (e.g., work cell phone, register station, two-way communication device, etc.). In some embodiments, the employee alert process 154 is configured to generate an employee notification for multiple employee devices 26a-26c registered to a single employee. For example, the employee alert process 154 can generate an alert for one or more personal devices of the employee and for one or more employer-issued devices. The alert can include any suitable type of electronic alert including, but not limited to, text messages, e-mail, instant/chat/direct messages, phone calls (e.g., text-to-voice, prerecorded, etc.), sound files (e.g., text-to-voice, prerecorded, etc.), push notifications, and/or any other suitable alert.

In some embodiments, the employee alert process 154 is configured to generate an alert for one or more employee devices 26a-26c that are registered to employees assigned to and/or responsible for the monitored area of the store. For example, retail employees may be assigned to specific departments, desks, locations, etc. within a retail environment. When a retail employee is assigned to a predetermined area of a store that is monitored by the image recognition process 152, the employee logs into or is otherwise associated with a first employee device 26a. The first employee device 26a is registered with the employee alert process 154 as being a device designated for the predetermined area of the store. When a person is detected within the predetermined area and/or additional rules are met, the employee alert process 154 identifies the first employee device 26a as being registered to the predetermined area and generates an alert for the first employee device 26a.

In some embodiments, the employee alert process 154 may select a first set of employee devices 26a-26c for a first notification and a second set of employee devices 26a-26c for a second notification. For example, in some embodiments, when a first person is detected within a predetermined area of the store by the image recognition process 152, the employee alert process 154 generates a first alert for a first employee device 26a registered to an employee assigned to the predetermined area. If the first person is still detected within the predetermined area after a predetermined time period, the employee alert process 154 may generate a second alert for the first employee device 26a and/or a second employee device 26b. The second employee device 26b may be registered to a second employee assigned to the predetermined area, an employee designated as a backup for the predetermined area, an employee designated as a manager or other supervisor for the first employee, and/or any other suitable employee. The employee alert process 154 may continue to generate alerts for the selected employee devices 26a, 26b and/or additional or alternative employee devices 26c based on additional rules implemented in a hierarchical manner.

As another example, in some embodiments, when a first person is detected within a predetermined area of the store by the image recognition process 152, the employee alert process 154 generates a first alert for a first employee device 26a registered to a first employee assigned to the predetermined area. If a second person is subsequently detected within the predetermined area, the employee alert process 154 generates a second alert for the first employee device 26a and/or a second employee device 26b. The second employee device 26b may be assigned to a second employee assigned to the predetermined area to assist with overflow (e.g., additional customers) such that any one customers wait time is reduced.

As yet another example, in some embodiments, when a first person is detected within a predetermined area of the store by the image recognition process 152, the employee alert process 154 generates a first alert for first set of employee devices 26a-26c, each registered to an employee assigned to or associated with the predetermined area. One of the employee devices 26a-26c, such as a first employee device 26a, may respond with an acknowledgment, indicating that the employee associated with the first employee device 26a has seen the alert and is in the process of helping the first person identified by the image recognition process 152. If a second person is detected within the predetermined area of the store by the image recognition process 152, the employee alert process 154 generates a second alert for a second set of employee devices 26a-26c. For example, the second alert may be provided only to the second employee device 26b and the third employee device 26c as the first employee device 26a is associated with an employee already helping the first person.

Although specific examples are discussed herein, it will be appreciated that the employee alert process 154 can be configured to generate any number of alerts to any number or subset of employee devices 26a-26c registered with the employee alert process 154. For example, in various embodiments, the employee alert process 154 can be configured to generate employee alerts based on any of the foregoing rules, combinations thereof, and/or additional rules. In some embodiments, the employee alert process 154 may be configured to generate multiple alerts for multiple employee devices registered to one or more employees according to different sets of rules implemented for different employees and/or sets of employees. After generating an alert, the alert monitoring process 154 continues to poll the centralized cache storage to identify additional persons and/or predetermined time periods for generating additional alerts.

In some embodiments, the employee alert process 154 (and/or additional or alternative processes) are configured to generate statistics, reports, and/or other data regarding the number of alerts generated, responsiveness of employees to generated alerts, average wait time for a person within the predetermined area, etc. The generated statistical data can be stored in one or more storage locations, such as the centralized cache store 30. Additional systems or processes may be configured to review the statistical data to generate metrics such as employee responsiveness, store foot traffic, customer engagement, etc.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A system, comprising:
a non-transitory memory having instructions stored thereon; and
a processor configured to read the instructions to:
receive a registration of at least a first device and a second device, wherein the registration associates each of the first device and the second device with a predetermined first area;
receive image data from at least one imaging device configured to provide a field-of-view including the predetermined first area associated with a retail location, wherein the image data is received in response to motion of one or more objects within the predetermined first area;
in response to receiving the image data, implement an image recognition process configured to identify a first person in the image data corresponding to the predetermined first area;
in response to determining that one or more predetermined rules associated with a first notification has been satisfied, generate a first alert indicating the first person is identified within the predetermined first area in the image data;
transmit the first alert to at least the first device;
identify a second person in the image data corresponding to the predetermined first area, wherein the second person is distinct from the first person;
in response to determining that one or more predetermined rules associated with a second notification has been satisfied, generate a second alert indicating the second person is identified within the predetermined first area; and
transmit the second alert to at least the second device.

2. The system of claim 1, wherein the processor is configured to:
receive a registration of a third device associating the third device with the predetermined first area;
track the first person within the image data; and
generate a third alert indicating the first person is within the predetermined first area a predetermined time period after the first alert, and wherein the third alert is transmitted to at least the third device.

3. The system of claim 1, wherein the first alert is provided to a centralized cache that includes the one or more cache stores, and wherein the first device is configured to poll the centralized cache.

4. The system of claim 1, wherein the first alert is generated when the first person is identified in a first frame of the image data and a second frame of the image data, and wherein the first person is within the predetermined first area in each of the first frame and the second frame.

5. The system of claim 4, wherein the first frame and the second frame are separated by a predetermined number of frames in the image data.

6. The system of claim 1, wherein the one or more predetermined rules associated with a first notification include an elapsed time since detection of the first person in the image data.

7. The system of claim 1, wherein the one or more predetermined rules associated with the second notification include receiving an acknowledgement notification from the first device in response to the first notification.

8. The system of claim 1, wherein the motion of one or more objects within the first predetermined area is identified by at least one motion sensor.

9. A computer-implemented method, comprising:
receiving a registration of at least a first device and a second device, wherein the registration associates each of the first device and the second device with a predetermined first area;
receiving image data from at least one imaging device configured to provide a field-of-view including the predetermined first area associated with a retail location, wherein the image data is received in response to motion of one or more objects within the predetermined first area;
in response to receiving the image data, implementing an image recognition process configured to identify a first person in the image data corresponding to the predetermined first area;
in response to determining that one or more predetermined rules associated with a first notification has been satisfied, generating a first alert indicating the first person is identified within the predetermined first area in the image data;
transmitting the first alert to at least the first device;
identifying a second person in the image data corresponding to the predetermined first area, wherein the second person is distinct from the first person;
in response to determining that one or more predetermined rules associated with a second notification has been satisfied, generating a second alert indicating the second person is identified within the predetermined first area; and
transmitting the second alert to at least the second device.

10. The computer-implemented method of claim 9, comprising:
receiving a registration of a third device associating the third device with the predetermined first area;
tracking the first person within the image data; and
generating a third alert indicating the first person is within the predetermined first area a predetermined time period after the first alert, and wherein the third alert is transmitted to at least the third device.

11. The computer-implemented method of claim 9, wherein the first alert is provided to a centralized cache that includes the one or more cache stores, and wherein the first device is configured to poll the centralized cache.

12. The computer-implemented method of claim 9, wherein the first alert is generated when the first person is identified in a first frame of the image data and a second frame of the image data, and wherein the first person is within the predetermined first area in each of the first frame and the second frame.

13. The computer-implemented method of claim 12, wherein the first frame and the second frame are separated by a predetermined number of frames in the image data.

14. The computer-implemented method of claim 9, wherein the one or more predetermined rules associated with a first notification include an elapsed time since detection of the first person in the image data.

15. The computer-implemented method of claim 9, wherein the one or more predetermined rules associated with the second notification include receiving an acknowledgement notification from the first device in response to the first notification.

16. The computer-implemented method of claim 9, wherein the motion of one or more objects within the first predetermined area is identified by at least one motion sensor.

17. A non-transitory computer readable medium having instructions stored thereon, wherein the instructions, when executed by a processor cause a device to perform operations comprising:
receiving a registration of at least a first device and a second device, wherein the registration associates each of the first device and the second device with a predetermined first area;
receiving image data from at least one imaging device configured to provide a field-of-view including the predetermined first area associated with a retail location, wherein the image data is received in response to motion of one or more objects within the predetermined first area;
in response to receiving the image data, implementing an image recognition process configured to identify a first person in the image data corresponding to the predetermined first area;
in response to determining that one or more predetermined rules associated with a first notification has been satisfied, generating a first alert indicating the first person is identified within the predetermined first area in the image data;
transmitting the first alert to at least the first device;
identifying a second person in the image data corresponding to the predetermined first area, wherein the second person is distinct from the first person;
in response to determining that one or more predetermined rules associated with a second notification has been satisfied, generating a second alert indicating the second person is identified within the predetermined first area; and
transmitting the second alert to at least the second device.
